(19) United States
(12) Patent Application Publication
(10) Pub. No.: US 2023/0355363 A1
(43) Pub. Date: Nov. 9, 2023

(54) NOVEL ORAL CARE DEVICE WITH UNIQUE SNAP-ON AND DISPOSABLE DENTAL PICKS

(71) Applicant: Boris Kaylakov, Rego Park, NY (US)

(72) Inventor: Boris Kaylakov, Rego Park, NY (US)

(21) Appl. No.: 18/142,792

(22) Filed: May 3, 2023

Related U.S. Application Data
(60) Provisional application No. 63/338,218, filed on May 4, 2022.

(51) Int. Cl. A61C 15/02

(52) U.S. Cl. CPC A61C 15/02

(57) ABSTRACT

An oral care device for interdental cleaning is provided. The oral care device comprises a handle and an interchangeable and snap-on head with two parallel picks. The handle allows a user to hold the device. The handle has one of a slot, indentation and fitting that promotes interchangeable attachment of a snap-on concave head. The snap-on head at its center or midpoint attaches to one end of handle via the slot. Said head has two parallel picks, one pick attached at each end. The device facilitates cleaning between teeth including front and back teeth. The device facilitates cleaning between teeth both from inside (tongue side) and outside (cheek side). The device facilitates cleaning between upper and lower teeth simultaneously with a first pick between two upper teeth and a second pick between two lower teeth. Soft picks facilitate massaging of gums, improving blood flow and promoting stronger and healthier gums.

### CROSS REFERENCE TO RELATED APPLICATIONS

The present non-provisional patent application is related to U.S. Provisional Pat. Application No. 63/338,218 filed May 4, 2022, the contents of which are incorporated herein in their entirety.

### FIELD OF THE DISCLOSURE

The present disclosure is in the field of oral care. More specifically, the present disclosure provides systems and methods of an ergonomically shaped handheld device that accommodates a dental pick for dental and gum care that performs multiple oral hygiene functions quickly, effectively, and safely.

### BACKGROUND

Removal of dental plaque by oral hygiene appliances should be performed daily. A common toothbrush is used to remove food debris and bacteria from surfaces of teeth. Floss, dental picks, and proxy brushes clean between adjacent teeth. Existing long-handheld proxy brushes and picks give better control. It can be difficult with such brushes and picks to get all areas clean, because such existing long-handheld proxy brushes and picks are not designed for both effective and quick cleaning between teeth.

Flossing is effective, but flossing takes time and effort. Most people therefore perform flossing less often than recommended. Existing long-handheld proxy brushes and picks also often cause pain, bleeding gums and significant discomfort. People with braces, dental bridges and crowns in particular struggle on a daily basis to keep these appliances clean. Effortless and thorough interdental cleaning with fixed appliances is difficult. A need therefore exists for oral hygiene tools capable of interdental cleaning that are both effective and easy to use. Most existing devices fail in either or both ergonomics and effectiveness.

### BRIEF DESCRIPTION OF THE FIGURES

FIG. 1 is an image of the handle with a female attachment that snap onto a male attachment of the head according to an embodiment of the present disclosure.

FIG. 2 is an image of the head with two permanently attached parallel rubber long dental picks according to an embodiment of the present disclosure.

FIG. 3 is an image of assembled handle with snap on head and two parallel dental picks according to an embodiment of the present disclosure.

### DETAILED DESCRIPTION

Systems and methods described herein provide an elongated handle for oral care that combines two long rubber dental picks into one manual device. A handle allows a user to hold the device. One of the ends of the tool contains a slot, indentation or fitting that permit interchangeable attachment of snap-on concave head with two parallel rubber dental picks.

The concave head at its center or midpoint attaches to one end of handle via the slot. At each end of the head a long rubber pick is attached.

Systems and methods described herein may be distinguished over previous implementations by combining interchangeable snap-on parallel dental picks to provide a more advanced single device that will make interdental cleaning more effective than previously. The device provided herein may make interdental cleaning easy and effective since a user may need to expend less effort and obtain quicker and better results.

The device specifically promotes a user to clean between all teeth including front and back teeth. The device further promotes cleaning between teeth both from inside (or tongue side) and outside (or cheek side). Gentle rubber soft picks massage gums as a user cleans between teeth. In addition, the device is capable of cleaning between upper and lower teeth simultaneously. One soft pick cleans between two upper teeth and the other soft pick cleans between two lower teeth. This may be advantageous to a user as significantly less time is needed to clean between all teeth compared to previous implementations.

The device further promotes cleaning from both sides: buccal and lingual surfaces, interdentally. Besides cleaning between teeth, this device simultaneously massages gums, improving blood flow and promoting stronger and healthier gums.

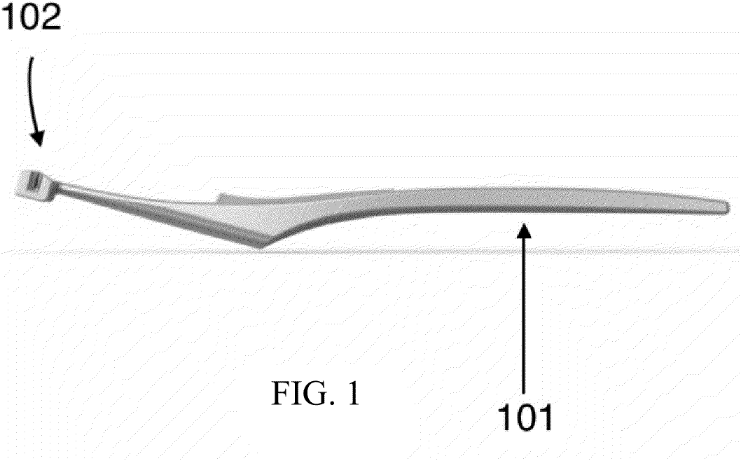

Turning to the figures, FIG. 1 depicts the handle 101 of the device without a snap-on head. An indentation or slot 102 on one end of the handle accommodates a snap-on attachment of head not depicted in FIG. 1.

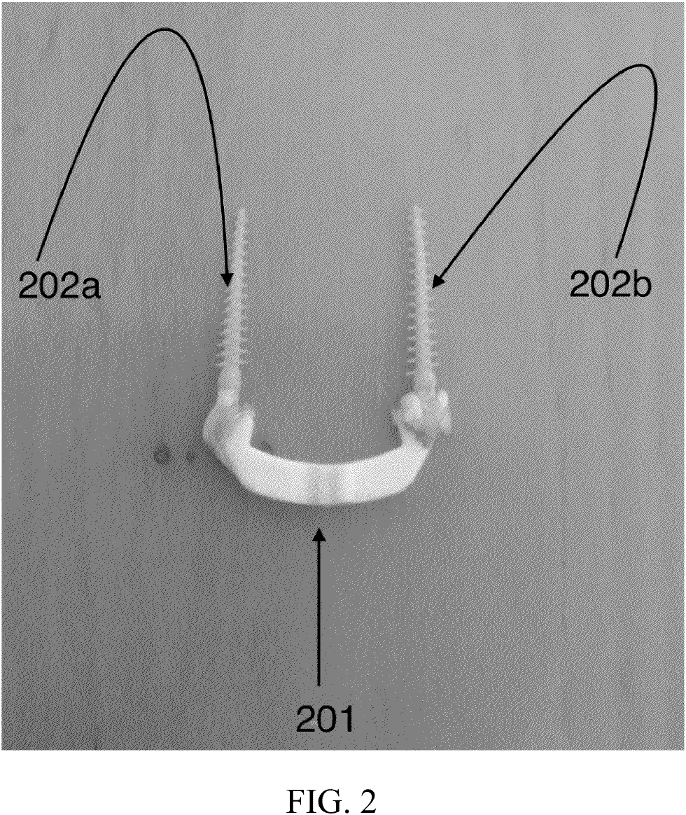

FIG. 2 depicts a concave head 201 with two parallel rubber dental picks 202a-b permanently attached to the given head on both sides.

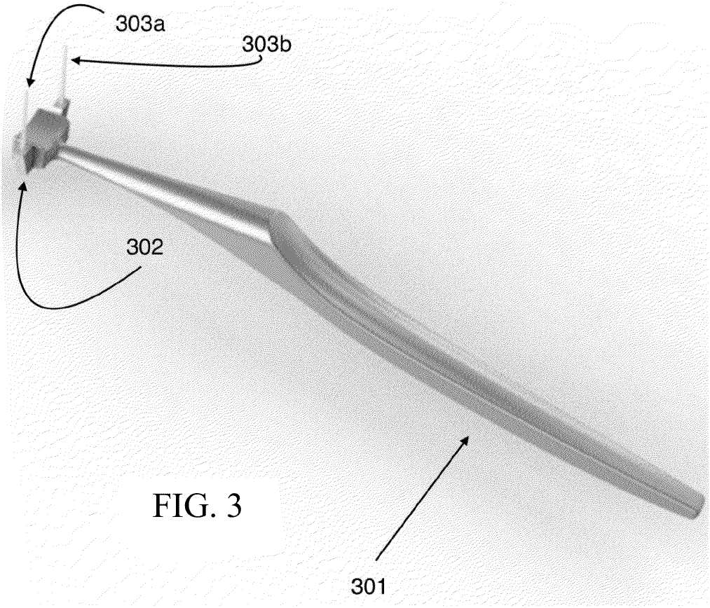

FIG. 3 depicts an assembled device of the present disclosure comprising handle 301, head 302, and two parallel rubber dental picks 303a-b.

In an embodiment, an oral care device for interdental cleaning is provided, the oral care device comprising a handle and an interchangeable and snap-on head with two parallel picks. The handle allows a user to hold the device. the handle has one of a slot, indentation and fitting that promotes interchangeable attachment of a snap-on concave head. The snap-on head at its center or midpoint attaches to one end of handle via the slot. Said head has two parallel picks, one pick attached at each end. The device facilitates cleaning between all teeth including front and back teeth. The device facilitates cleaning between teeth both from inside (tongue side) and outside (cheek side). The device facilitates cleaning between upper and lower teeth simultaneously with a first pick between two upper teeth and a second pick between two lower teeth. Soft picks facilitate massaging of gums, the massaging directed to improving blood flow and directed to promoting stronger and healthier gums.

It should be noted that the descriptions are for illustrative purposes only, and it is to be understood that changes and variations may be made without departing from the spirit or scope of the following claims.

What is claimed is:

1. An oral care device for interdental cleaning, the oral care device comprising a handle and an interchangeable and snap-on head with two parallel picks.

2. The device of claim 1, wherein the handle allows a user to hold the device.

3. The device of claim 1, wherein the handle has one of a slot, indentation and fitting that promotes interchangeable attachment of a snap-on concave head.

4. The device of claim 1, wherein the snap-on head at its center or midpoint attaches to one end of handle via the slot.

5. The device of claim 1, wherein said head has two parallel picks, one pick attached at each end.

6. The device of claim 1, wherein the device facilitates cleaning between all teeth including front and back teeth.

7. The device of claim 1, wherein the device facilitates cleaning between teeth both from inside (tongue side) and outside (cheek side).

8. The device of claim 1, wherein the device facilitates cleaning between upper and lower teeth simultaneously with a first pick between two upper teeth and a second pick between two lower teeth.

9. The device of claim 1, wherein soft picks facilitate massaging of gums, the massaging directed to improving blood flow and directed to promoting stronger and healthier gums.
